(19) United States
(12) Patent Application Publication
(10) Pub. No.: US 2020/0285596 A1
(43) Pub. Date: Sep. 10, 2020

(54) SWITCH DEVICE

(71) Applicant: KABUSHIKI KAISHA TOKAI RIKA DENKI SEISAKUSHO, Aichi (JP)

(72) Inventors: Rijin OWAKI, Aichi (JP); Yosuke OHASHI, Aichi (JP)

(73) Assignee: KABUSHIKI KAISHA TOKAI RIKA DENKI SEISAKUSHO, Aichi (JP)

(21) Appl. No.: 16/650,223

(22) PCT Filed: Sep. 21, 2018
(86) PCT No.: PCT/JP2018/035016

§ 371 Date: Mar. 24, 2020

(30) Foreign Application Priority Data
Sep. 29, 2017 (JP) 2017-190714

(51) Int. Cl. G06F 13/10; G06F 21/32

(52) U.S. Cl. CPC G06F 13/102; G06F 21/32

(57) ABSTRACT

A switch device includes a verification unit. The verification unit calculates a degree of similarity between biometric information read by a biometric information sensor and enrolled biometric information enrolled beforehand. If the degree of similarity is not less than a verification threshold, the verification unit determines that verification is successful. If the degree of similarity is smaller than the verification threshold and not less than the first threshold, the verification unit sets as a new verification threshold a second threshold larger than a first threshold and smaller than the verification threshold.

### CROSS-REFERENCES TO RELATED APPLICATIONS

The present patent application claims the priority of Japanese patent application No. 2017-190714 filed on Sep. 29, 2017, and the entire contents of Japanese patent application No. 2017-190714 are hereby incorporated by reference.

### TECHNICAL FIELD

The present invention relates to a switch device.

### BACKGROUND ART

An input device is known in which a fingerprint recognition sensor is mounted on at least one of plural push switches, the fingerprint recognition sensor reading fingerprint data to perform a verification by comparison between the read fingerprint data and a pre-enrolled fingerprint data to identify an individual based on the verification result, and a control unit performs verification when the push switch with the fingerprint recognition sensor is pushed down and thereby the control unit detects a push signal generated and transmitted therefrom (see, e.g., Patent Literature 1).

The input device is configured such that appropriate fingerprint data is easily read by the fingerprint recognition sensor to suitably perform the verification of fingerprint.

### CITATION LIST

### Patent Literature

Patent Literature 1: JP 2006/155455 A

### SUMMARY OF INVENTION

### Technical Problem

The input device disclosed in Patent Literature 1 may fail in a verification depending on the touch position of the finger or the condition of the finger even when an operation is performed by an enrolled operator. In this case, if a false acceptance rate thereof is increased, the verification may be loosened but the security level may decrease. If the security level is increased, the verification may be tightened and thus may be failed even when the enrolled operator operates, causing a decrease in usability.

It is an object of the invention to provide a switch device which can provide improved usability while ensuring the security level.

### Solution to Problem

According to an embodiment of the invention, a switch device comprises a verification unit, wherein the verification unit calculates a degree of similarity between biometric information read by a biometric information sensor and enrolled biometric information enrolled beforehand, wherein if the degree of similarity is not less than a verification threshold, the verification unit determines that verification is successful, and wherein if the degree of similarity is smaller than the verification threshold and not less than the first threshold, the verification unit sets as a new verification threshold a second threshold larger than a first threshold and smaller than the verification threshold.

According to an embodiment of the invention, it is possible to provide a switch device which can provide improved usability while ensuring the security level.

### BRIEF DESCRIPTION OF DRAWINGS

FIG. 1A is a perspective view showing a start switch device in an embodiment.

FIG. 1B is a front view showing the start switch device in the embodiment.

FIG. 2A is a block diagram illustrating the start switch device in the embodiment.

FIG. 2B is a graph showing degree of similarity and occurrence rate.

FIG. 3 is a flowchart showing an operation of the start switch device in the embodiment.

### DESCRIPTION OF EMBODIMENTS

### Summary of the Embodiment

A switch device in the embodiment has a verification unit that calculates a degree of similarity between biometric information sensor read by a biometric information sensor and enrolled biometric information enrolled beforehand, determines that verification is successful when the degree of similarity is not less than a verification threshold, and sets a second threshold larger than a first threshold and smaller than the verification threshold as a new verification threshold when the degree of similarity is smaller than the verification threshold and not less than the first threshold.

Even when verification fails at the first verification attempt, the switch device can set a new verification threshold lower than the verification threshold while ensuring the security level, hence, it is possible to improve usability while ensuring the security level, unlike when the verification threshold is fixed.

### Embodiment

### (General Configuration of Start Switch Device 1)

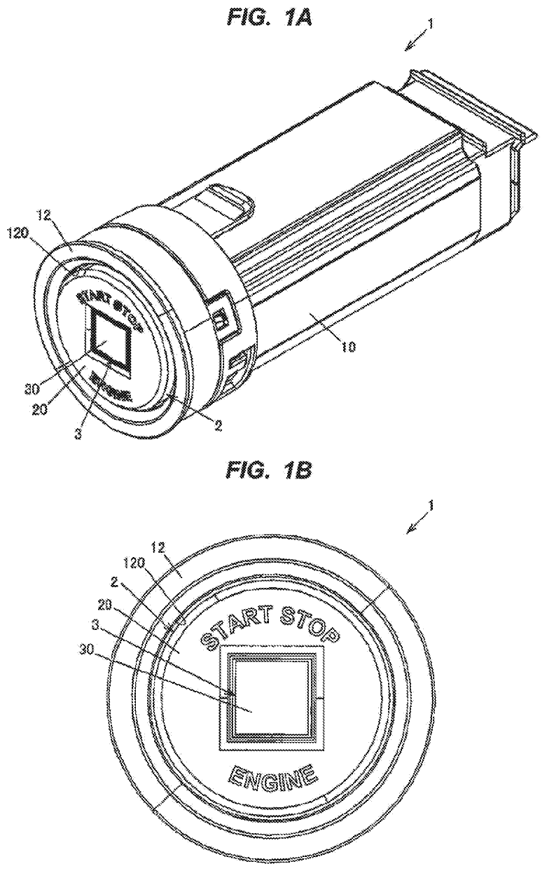

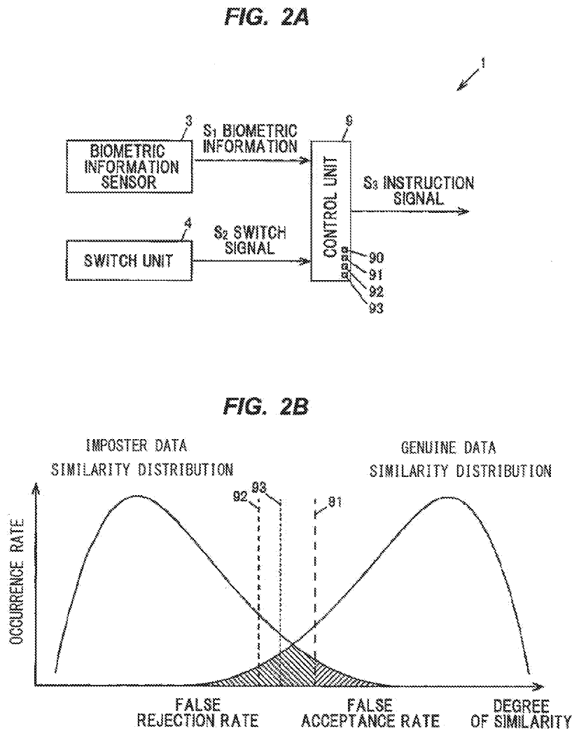

FIG. 1A is a perspective view showing a start switch device in an embodiment and FIG. 1B is a front view showing the start switch device in the embodiment. FIG. 2A is a block diagram illustrating the start switch device in the embodiment, and FIG. 2B is a graph showing degree of similarity and occurrence rate. In each drawing of the embodiment described below, a scale ratio may be different from an actual ratio. In addition, in FIG. 2A, flows of main signals and information are indicated by arrows.

The start switch device 1 as the switch device is provided with, e.g., an operation button 2 having an operation surface 20 to be push-operated, a biometric information sensor 3 arranged on the operation button 2 so that a reading surface 30 for reading biometric information S₁ is exposed on the operation surface 20, a switch unit 4 which detects a push operation performed on the operation button 2, and a control unit 9 as the verification unit, as shown in FIGS. 1A, 1B, 2A and 2B.

The control unit 9 of the start switch device 1 is configured to calculate a degree of similarity between the biometric information S₁ read by the biometric information sensor 3 and enrolled biometric information 90 which has been enrolled beforehand, to determine that verification is successful when the degree of similarity is not less than a verification threshold 91, and to set a second threshold 93 larger than a first threshold 92 and smaller than the verification threshold as a new verification threshold 91 when the degree of similarity is smaller than the verification threshold 91 and not less than the first threshold 92.

When the degree of similarity between the next read biometric information S₁ and the enrolled biometric information 90 is not less than the new verification threshold 91 (=the second threshold 93), the control unit 9 determines that verification is successful and the operator is the enrolled individual.

Meanwhile, the control unit 9 is also configure to not set a new verification threshold 91 when the degree of similarity is smaller than the first threshold 92, based on the determination that verification is failure.

When verification of the biometric information S₁ is successful and the switch unit 4 is in the on state, the control unit 9 outputs an instruction signal S3 to give an instruction to start a drive system of a vehicle.

In detail, as an example, the start switch device 1 is configured that the biometric information sensor 3 can read the biometric information S₁ after doors are unlocked upon authentication based on wireless communication with an electronic key, etc., and drive voltage is supplied from a battery of the vehicle.

In the vehicle, the drive system is started based on the instruction signal S3 which is output when the switch unit 4 is turned on by a push operation and verification of the biometric information S₁ is successful.

The drive system is, e.g., an internal combustion engine, a motor, or a combination thereof, etc. The start switch device 1 is configured to give an instruction to start/stop the drive system.

### (Configuration of the Operation Button 2)

The operation button 2 is arranged, e.g., inside a cylindrical body 10 as shown in FIGS. 1A and 1B. A bezel 12 is attached to an end of the body 10 and the operation surface 20 of the operation button 2 is exposed in an opening 120 of the bezel 12. The switch unit 4 is arranged on an end portion of the operation button 2 on the opposite side to the operation surface 20.

### (Configuration of the Biometric Information Sensor 3)

The biometric information sensor 3 is arranged at the center of the operation surface 20 of the operation button 2. The biometric information sensor 3 is configured that the reading surface 30 for reading the biometric information S₁ has a rectangular shape and is exposed on the operation surface 20. The position of the reading surface 30 is, e.g., lower than the operation surface 20.

The biometric information sensor 3 is configured to read the biometric information S₁ of an operating finger in contact with the operation surface 20. As an example, the biometric information S₁ includes image information of at least one of fingerprint pattern and vein pattern of the operating finger.

When configured to read, e.g., a fingerprint pattern, the biometric information sensor 3 is constructed from an optical, capacitive, electric field strength measuring, pressure-sensitive, or thermal sensor.

Meanwhile, when configured to read, e.g., a vein pattern, the biometric information sensor 3 is configured to read a vein pattern based on reflection of infrared radiation.

As an example, the biometric information sensor 3 in the present embodiment is a capacitive sensor which reads a fingerprint pattern. The biometric information sensor 3 outputs the read fingerprint pattern, as the biometric information S₁, to the control unit 9.

### (Configuration of the Switch Unit 41)

The switch unit 4 is a switch to be turned on by displacement of the operation button 2 due to a push operation, and is configured to be turned off when a load due to the push operation is removed.

When turned on, the switch unit 4 outputs a switch signals S₂ to the control unit 9. When the switch signals S₂ is input, the control unit 9 determines that a push operation is performed.

### (Configuration of the Control Unit 9)

The control unit 9 is, e.g., a microcomputer composed of a CPU (Central Processing Unit) performing calculation and processing, etc., of the acquired data according to a stored program, and a RAM and a ROM (Read Only Memory) which are semiconductor memories. The ROM stores, e.g., a program for operation of the control unit 9, the enrolled biometric information 90, the verification threshold 91, the first threshold 92 and the second threshold 93, The RAM is used as, e.g., a storage area for temporarily storing calculation results, etc.

As an example, the control unit 9 determines that an operator is the enrolled individual when the degree of similarity between the characteristic features of the fingerprint pattern of the operator based on the biometric information S₁ acquired from the biometric information sensor 3 and the characteristic features of the fingerprint pattern of the enrolled individual contained in the enrolled biometric information 90 is greater than the verification threshold 91.

When, e.g., it is determined that the operator is the enrolled individual and it is also determined based on an input of the switch signals S₂ that the switch unit 4 is in the on state, the control unit 9 generates the instruction signal S3 to give an instruction to start the drive system and outputs the instruction signal S3 to a vehicle control unit, etc.

Now referring to FIG. 2B, the distribution on the left represents imposter data similarity distribution and the distribution on the right represents genuine data similarity distribution. In FIG. 2B, the horizontal axis indicates the degree of similarity and the vertical axis indicates the occurrence rate. In the region in which the two distributions overlap, the area on the left side of the verification threshold 91 (the area shaded with diagonal lines sloping down to the right) is the False Rejection Rate (FRR) and the area on the right side (the area shaded with diagonal lines sloping up to the right) is the False Acceptance Rate (FAR).

When the verification threshold 91 is changed to a value on the right side on the paper of FIG. 2B, the security level is improved due to stricter verification but the usability decreases. The decrease in usability means that there is more likelihood that the biometric information S₁ will need to be read several times since successful verification does not occur without a high degree of similarity, and this decreases convenience.

Meanwhile, when the verification threshold 91 is changed to a value on the left side on the paper FIG. 2B, usability is improved due to easier verification but the security level decreases. As such, the security level and the usability are in a trade-off relation.

Thus, in the present embodiment, when, e.g., the degree of similarity at the first verification attempt is smaller than the verification threshold 91 and not less than the first threshold 92, the control unit 9 uses the second threshold 93 as a new verification threshold 91 (=the second threshold 93) for the next verification and onward. This means that verification at the first verification attempt is failure.

Then, the control unit 9 calculates the degree of similarity between the next read biometric information S₁ and the enrolled biometric information 90, and when this degree of similarity is not less than the newly set verification threshold 91 (=the second threshold 93), the control unit 9 determines that the operator is the enrolled individual. Meanwhile, when this degree of similarity is smaller than the first threshold 92, the control unit 9 determines that verification is failure. Furthermore, when this degree of similarity is not less than the first threshold 92 and smaller than the verification threshold 91 the second threshold 93), the control unit 9 calculates the degree of similarity between the further next biometric information S₁ and the enrolled biometric information 90 and performs verification using the verification threshold 91 (=the second threshold 93).

In a modification of verification, for example, the number of retries within a certain period of time may be set, or a time limit for retries may be set. For example, the control unit 9 counts and measures the number of performed verification attempts and the elapsed time since the first verification attempt, and when the number of retries exceeds the limit, the control unit 9 stops performing verification even still in time. Meanwhile, when, e.g., a time limit is set, the control unit 9 measures time from the first verification attempt and stops performing verification when exceeding the time limit. The stop of verification may be, e.g., suspension of verification for a certain period of time, suspension continued until cancellation of the suspension, or stop of performing verification with the new verification threshold 91 and back to verification with the original verification threshold 91. In the present embodiment, when exceeding the time limit, verification with the new verification threshold 91 is stopped and verification is performed with the original verification threshold 91.

The control unit 9 preferably sets the new verification threshold 91 the second threshold 93) within, e.g., the range of the false rejection rate defined by the verification threshold 91, as shown in FIG. 28. The range of the false rejection rate is, e.g., the range indicated by diagonal lines sloping down to the right on the paper of FIG. 2B. This is because if the second threshold 93 is out of the range of the false rejection rate and has a value with a low degree of similarity, the security level significantly decreases as compared to when within the range.

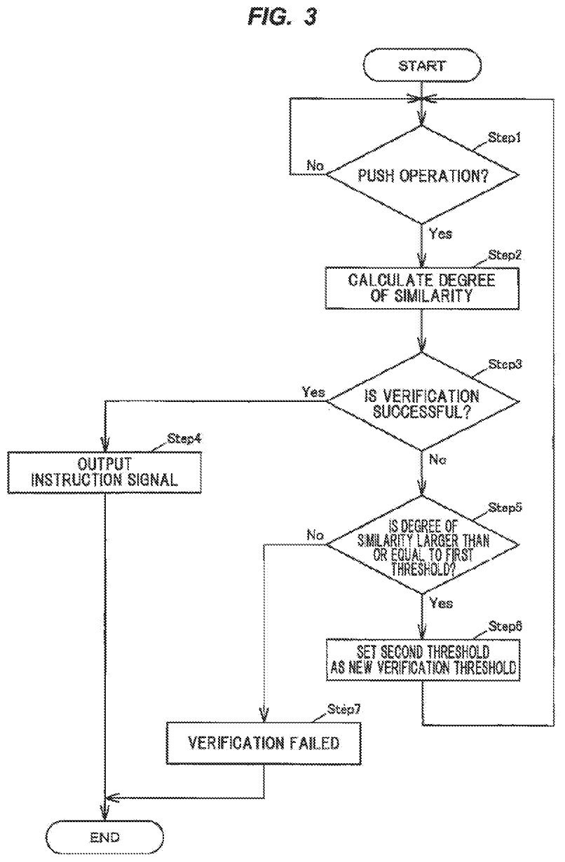

Next, an example of an operation of the start switch device 1 in the present embodiment to start the drive system will be described in reference to the flowchart of FIG. 3.

### (Operation)

The of the control unit 9 of the start switch device 1 determines that a push operation is performed when it is “Yes” in Step 1, i.e., when the switch signals S₂ is input from the switch unit 4 (Step 1: Yes).

Then, based on the biometric information S₁ read at the time of the push operation and the enrolled biometric information 90, the control unit 9 calculates the degree of similarity (Step 2). After that, when the calculated degree of similarity is not less than the verification threshold 91 (Step 3: Yes), the control unit 9 determines that verification is successful, and the control unit 9 outputs the instruction signal S3 to give an instruction to start the drive system (Step 4).

When verification is failure in Step 3 (Step 3: No), the control unit 9 compares the degree of similarity with the first threshold 92. When the degree of similarity is not less than the first threshold 92 (Step 5: Yes), the control unit 9 sets the second threshold 93 as a new verification threshold 91 (Step 6), and the process proceeds to Step 1 to monitor whether a push operation is performed or not.

The control unit 9 changes back to the original verification threshold 91 when, e.g., a push operation is not determined or verification is failure within a predetermined time limit after setting the second threshold 93 as a new verification threshold 91.

When the degree of similarity is smaller than the first threshold 92 in Step 5 (Step 5: No), the control unit 9 determines failure of verification and terminates verification (Step 7).

Regarding determination of push operation and verification, verification is performed after the push operation is determined in the above example, but it is not limited thereto. For example, the push operation may be determined after successful verification.

Meanwhile, when stopping the drive system, the start switch device 1 is triggered by an input of the switch signals S₂ and outputs the instruction signal S3 for stopping the drive system, without performing verification of the biometric information S₁.

### Effects of the Embodiment

The start switch device 1 in the present embodiment can provide improved usability while ensuring the security, in detail, even when verification fails at the first verification attempt, the start switch device 1 can set a new verification threshold 91 the second threshold 93) lower than the verification threshold 91 while ensuring the security, as long as the degree of similarity is not less than the first threshold 92. Therefore, the start switch device 1 can improve usability while ensuring the security, unlike when the verification threshold is fixed.

The start switch device 1 can lower the verification threshold 91 when the first verification attempt fails and the degree of similarity is not less than the first threshold 92. Therefore, probability of successful verification at the next push operation is increased as compared to when not lowered. In addition, the start switch device 1 does not lower the verification threshold 91 when the degree of similarity is smaller than the first threshold 92. Therefore, unlike when such a configuration is not adopted, it is possible to prevent unenrolled individuals from internationally lowering the verification threshold 91 by continuously performing the push operations.

The start switch device 1 sets the second threshold 93 to be a new verification threshold 91 within the range of the false rejection rate. Therefore, unlike when such a configuration is not adopted, it is possible to facilitate verification while maintaining the security level.

As a modification, the verification threshold 91 may be changed between plural thresholds, in addition to the second threshold 93.

Although some embodiment and modifications of the invention have been described, the embodiment and modifications are merely an example and the invention according to claims is not to be limited thereto. The new embodiment and modifications may be implemented in various other forms, and various omissions, substitutions and changes, etc., can be made without departing from the gist of the invention. In addition, all combinations of the features described in the embodiment and modifications are not necessary to solve the problem of the invention. Further, the embodiment and modifications are included within the scope and gist of the invention and also within the invention described in the claims and the range of equivalency.

### REFERENCE SIGNS LIST

1 START SWITCH DEVICE
2 OPERATION BUTTON
3 BIOMETRIC INFORMATION SENSOR
4 SWITCH UNIT
9 CONTROL UNIT
20 OPERATION SURFACE
30 READING SURFACE
90 ENROLLED BIOMETRIC INFORMATION
91 VERIFICATION THRESHOLD
92 FIRST THRESHOLD
93 SECOND THRESHOLD

1. A switch device, comprising a verification unit,
wherein the verification unit calculates a degree of similarity between biometric information read by a biometric information sensor and enrolled biometric information enrolled beforehand,
wherein if the degree of similarity is not less than a verification threshold, the verification unit determines that verification is successful, and
wherein if the degree of similarity is smaller than the verification threshold and not less than the first threshold, the verification unit sets as a new verification threshold a second threshold larger than a first threshold and smaller than the verification threshold.

2. The switch device according to claim 1, wherein, if the new verification threshold is set, the verification unit repeatedly performs a verification process until the degree of similarity becomes not less than the new verification threshold, the verification process ending at the determination of successful verification or the setting of a new verification threshold.

3. The switch device according to claim 1, wherein the verification unit sets the new verification threshold within a range of a false rejection rate defined by the verification threshold.

4. The switch device according to claim 1, wherein, if the degree of similarity is smaller than the first threshold, the verification unit determines failure of verification and does not set the new verification threshold.

5. The switch device according to claim 1, wherein the verification unit calculates the degree of similarity based on the characteristic features of a fingerprint pattern as the biometric information read by the biometric information sensor and the characteristic features of an enrolled fingerprint pattern as the enrolled biometric information.

6. The switch device according to claim 1, wherein the verification unit counts and measures the number of the verification processes and the elapsed time since the first verification process, and if the number of the verification processes exceeds a predetermined number or the elapsed time exceeds a predetermined time, the verification unit stops proceeding to a new verification process.

7. The switch device according to claim 6, wherein, as the stop of proceeding to a new verification process, the verification unit performs one of suspension for a predetermined time, suspension until cancellation of the suspension, or switching from the verification process using the new verification threshold to the verification process using the original verification threshold.

8. The switch device according to claim 1, comprising:
an operation button comprising an operation surface to be push-operated;
the biometric information sensor arranged on the operation button so that a reading surface for reading the biometric information is exposed on the operation surface; and
a switch unit that detects a push operation performed on the operation button.

9. The switch device according to claim 8, wherein, if verification of the biometric information is successful and the switch unit is turned on, the verification unit outputs an instruction signal for giving an instruction to start a drive system of a vehicle.

10. The switch device according to claim 8, wherein the biometric information sensor is arranged at a center of the operation surface of the operation button.
